(19) United States
(12) Patent Application Publication
(10) Pub. No.: US 2007/0250576 A1
(43) Pub. Date: Oct. 25, 2007

(54) METHOD AND SYSTEM FOR AUTOMATICALLY PROVIDING AN ABSTRACT OF A RESPONSE MESSAGE IN A SUBJECT LINE OF THE RESPONSE MESSAGE

(76) Inventors: Shruti Kumar, Littleton, MA (US); Niklas Heidloff, Salzkotten (DE); Michael R. O'Brien, Westford, MA (US); Paul L. Wilson, Cambridge, MA (US)

Correspondence Address: LOTUS AND RATIONAL SOFTWARE;McGuinness & Manaras LLP, 125 NAGOG PARK, ACTON, MA, 01720, US

(21) Appl. No.: 11/379,594

(22) Filed: Apr. 21, 2006

(51) Int. Cl. G06F 15/16

(52) U.S. Cl. 709/206

(57) ABSTRACT

A system for making the contents of the “Subject:” field of a response email message more meaningful and more useful within a conversation thread of email messages by providing an abstract of the response message within the “Subject:” field. Before a response message is sent, the system automatically generates at least one new subject line that it proposes to the user for use in the “Subject:” field of the response message. The system generates a user interface display of a number of proposed subject lines, and also provides the user with the options of accepting, modifying, or declining the proposed subjects lines. The displayed contents of a “Subject:” field for the response message contains the currently selected one of the proposed subject lines. A predetermined one of the proposed subject lines may be provided as an initial default value of the “Subject:” field. The system generates the proposed subject lines using auto-summarization techniques, which are performed using various text analysis and information retrieval techniques based on attributes of the response message.

### FIELD OF THE INVENTION

The present invention relates generally to electronic messaging systems, such as electronic mail (“email”), and specifically to a method and system for providing an abstract of a response message in the subject line of the response message.

### BACKGROUND OF THE INVENTION

Electronic messaging systems, such as electronic mail (“email”), have become ubiquitous for both business and personal use. Examples of email applications include Microsoft® Outlook, Eudora, and Web based email systems provided through an Internet browser program, such as services provided by Google, Yahoo, and other Web portal providers. Email systems are often architected in a client-server software model, in which client software is provided in end user computer systems to enable users to compose, send and receive messages, while a server software component is provided to perform various centralized functions.

Typical email applications provide a user with a graphical user interface through which messages can be composed and sent, and through which messages can also be received. A number of mailbox constructs are usually maintained for the user, including an Inbox to store received messages, an Outbox into which messages are put pending being sent, and a Sent mailbox for storing messages that have previously been transmitted. An email message usually includes or is associated with a list of destination addresses or user names identifying recipients to which the message is to be delivered (“addressees”), sometimes referred to as a “To:” field. Other addressees may be indicated in a carbon copy “Cc:” field, or in a blind carbon copy “Bcc:” field. A “From:” field is also included or associated with a message, and identifies the sender of the message. A “Subject:” field for an email message includes a text string defining the subject of the message. A message body contains the content of the message, including text, images, links, or other content. A number of separate documents may also be attached to the message before it is sent, containing additional content to that contained within the message body. After the message body, destination email addresses, and any attachments to the message are defined, the user can click on a “Send” button or the like to cause the message to be sent.

When a message is received, the email client software provides the receiving user with the ability to generate a response to the received message, for example by way of a “Reply” and/or “Reply All” button within the graphical user interface. Clicking on the “Reply” button sets up a response message, which may include the received message, for editing and sending back to the original sender of the received message. Clicking on the “Reply All” button similarly sets up a response message for editing and sending back to the original sender and any other recipients of the original message.

A series of received messages that are direct or indirect replies to an original “root” message may be referred to as a message “thread”. The reply messages in a thread may be considered child messages under the original root message. In addition to the reply messages, a thread may or may not be considered to also include the original root message. In an email system, a thread may consist of a number of received messages stored in a user's Inbox, or another mailbox structure provided by the email system. Messages within a thread may be transmitted or received over potentially long periods of time, and a thread may sit dormant for a time period before it is resumed when a new message is added to it.

Some existing email systems have attempted to display message threads in a user friendly way by using what are referred to as “gathered” threads views. For example, in a gathered threads view, received messages belonging to a thread may be represented using a single message entry or using a proximately displayed group of entries in the user's Inbox. One example of a gathered threads view of message threads is found in the “conversations” view displayed by the Gmail™ email system from Google®.

A problem arises in existing systems with regard to the contents of the “Subject:” field for a response message. Typically, email users will enter a relatively “good” “Subject:” field contents when they create a new email message, in that the entered “Subject:” field contents for a new message is significantly descriptive of the new message. However, email users often do not change the “Subject:” field contents when they respond to a received email message. As a result, the “Subject:” field contents of many email response messages is often “Re:<original subject>”, where <original subject> is text completely taken straight from the “Subject:” field contents of the original received message by the email system. This technique for generating the contents of a “Subject:” field for a response message is the default approach provided by many existing systems, and results in “Subject:” field contents that are not descriptive of the response message, beyond the fact that it is a response to a certain received message having a certain subject.

The shortcomings of existing systems in generating “Subject:” field contents for response messages is further exacerbated in the gathered threads views sometimes provided by email system user interfaces. In such views, the automatically generated “Subject:” field contents does not provide useful information about the response messages in the conversation, or effectively represent the changing conversation context, since the original subject line typically just repeats over and over again.

Most existing email clients allow users to expressly change the contents of the “Subject:” field of a response message by typing in new text. However, existing systems do not provide any mechanism that attempts to automatically generate a new “Subject:” field contents that is more meaningful with regard to the contents of a response, or that reflects the changing context of an ongoing email conversation. The Gmail™ email system from Google® tries to solve this problem by displaying the beginning of each email message's content within the message entry in a user's Inbox. However, the contents of this preview of a message's contents cannot be changed by the user. Moreover, many times the beginning of an email message does not provide a useful abstract of the message contents

For these reasons and others, it would be desirable to have a new system for generating the contents of a “Subject:” field for a response message to a received email message. The system should automatically assist the sender of the response message in determining a useful contents for the “Subject:” field of the response message, based on attributes of the response message.

### SUMMARY OF THE INVENTION

To address the above described and other shortcomings of existing systems, a method and system are disclosed for making the contents of the “Subject:” field more meaningful for response email messages by generating proposed subject lines based on attributes of the response message for user selection and insertion into the “Subject:” field of the response message.

The disclosed system automatically generates at least one new, proposed subject line that it displays to the user for possible insertion into the “Subject:” field of a response message that has not yet been sent. In one embodiment, the disclosed system automatically generates one or more proposed subject lines only in the event that the user has not explicitly changed the contents of the “Subject:” field for the response message from its original contents. Such original contents may, for example, consist of or include the contents of the “Subject:” field from the original received message, and additional text indicating that the message is a response, such as the pre-pended text “Re:”.

In the event that one or more proposed subject lines are generated, the disclosed system may provide a proposed subject line user interface display showing the generated proposed subject line(s). In one embodiment, the proposed subject line user interface is displayed in response to a triggering user action, such as the user requesting that the response message be sent, for example by clicking on a SEND button in the user interface. The proposed subject line(s) may be derived using various auto-summarization techniques, based on various attributes of the response message created by the responding user, such as any new contents added to the response message, files attached to the response message, links added to the response message and/or the content identified by any such links, the contents of the “Subject:” field from the original received message, any new addressees to which the response message is being sent, as well as the contents of an important persons list. The auto-summarization performed to generate the proposed subject lines may be accomplished using various specific text analysis and information retrieval techniques.

The disclosed system provides the user with the options of accepting, modifying, or declining the proposed subject lines. A proposed subject line user interface provides the user with the following options:

a. ACCEPT one of the proposed subject lines;

b. MODIFY one of the proposed subject lines; or

c. DECLINE all the proposed subject lines.

The contents of a “Subject:” field for the response message may be displayed containing a currently selected one of the proposed subject lines. A predetermined one of the proposed subject lines may be a default proposed subject line.

In this way there is disclosed a new system for generating the contents of a “Subject:” field for a response message to a received email message. The disclosed system advantageously assists the sender of a response message in determining a useful contents for the “Subject:” field of the response message, by offering one or more automatically generated proposed subject lines derived from attributes of the response message.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is a block diagram showing hardware and software components including an illustrative embodiment of the disclosed system;

FIG. 2 is a simplified portion of a screen shot showing a portion of a user interface generated in accordance with an illustrative embodiment of the disclosed system;

FIG. 3 is a simplified portion of a screen shot showing a proposed subject line dialog box generated in accordance with an illustrative embodiment of the disclosed system;

FIG. 4 is a simplified screen shot showing a portion of an Inbox user display generated by a prior art system;

FIG. 5 is a simplified screen shot showing a portion of an Inbox user display generated in accordance with an illustrative embodiment of the disclosed system; and

FIG. 6 is a flow chart showing steps of operation performed in accordance with an illustrative embodiment of the disclosed system.

### DETAILED DESCRIPTION OF EXEMPLARY EMBODIMENTS

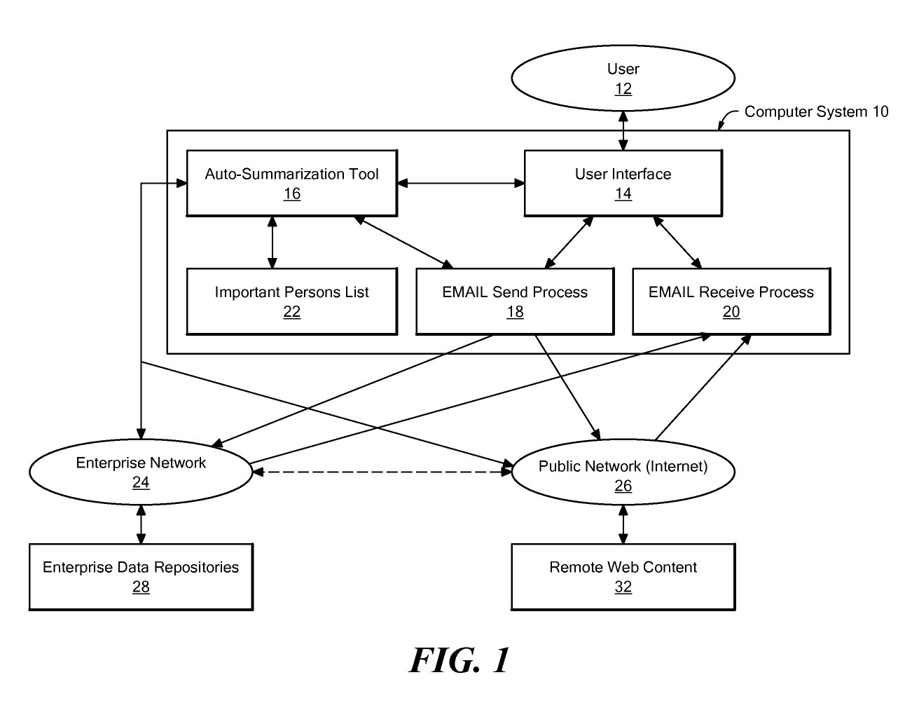

As shown in FIG. 1, hardware and software components including an embodiment of the disclosed system include a computer system 10 that is communicable with an Enterprise Network 24 and a Public Network 26, such as the Internet. The computer system 10 may, for example, include at least one processor, program storage, such as memory, for storing program code executable on the processor, and one or more input/output devices and/or interfaces, such as data communication and/or peripheral devices and/or interfaces. The computer system 10 may further include appropriate operating system software.

The Enterprise Network 24 may, for example, consist of a private communication network operated by a business enterprise that controls a number of Enterprise Data Repositories 28 that are reachable through the Enterprise Network 24. Such Enterprise Data Repositories may include various types of content, such as databases, Web pages, collaborative work spaces, and others. The Public Network 26 provides access to Remote Web Content 32, which may similarly include the previously described and other specific types of content.

The computer system 10 has a number of software programs and/or processes executing thereon, including an Email Send Process 18 and an Email Receive Process 20, which operate together to provide a User Interface 14 to a user 12. An Auto-Summarization Tool 16 also executes on the Computer System 10, and operates in communication with the Email Send Process 18 and an Important Persons List 22.

During operation of the components shown in FIG. 1, the Email Send Process 18 and Email Receive Process 20 operate to send and receive email messages respectively on behalf of the user 12. The Email Send Process 18 and Email Receive Process 20 may, for example, be part of an email client application program that uses a messaging system based on a protocol such as the Simple Mail Transfer Protocol (SMTP). When the User 12 creates a response message to a received email message through the User Interface 14, the Email Send Process 18 operates in cooperation with the Auto-Summarization Tool 16 to generate one or more proposed summary lines to be used in the “Subject:” field of the response message. The proposed subject lines are generated by the Auto-Summarization Tool 16 in response to new content added by the User 12 to the response message, any attachments to the response message attached by the User 12, any links included in the new content of the response message, as well as the content indicated by such links, any new addressees introduced to the response message by the User 12, and/or the contents of the Important Persons List 87. The Email Send Process 18 and/or Auto-Summarization Tool 16 further operate to provide a portion of the User Interface 14 that displays the proposed subject lines to the User 12, and enables the User to 12 to select one of the proposed subject lines for use within the “Subject:” field of the response message. The response message may as a result be transmitted through the Email Send Process 18 including any such user selected proposed subject line as the contents of its “Subject:” field.

The Important Persons List 22 includes indications of persons that are important to the user 12. Such indications may, for example, consist of email addresses, user names, or other types of indications of important persons. The Important Persons List 22 may be defined by the user 12 through the User Interface 14, may be defined by a system administrator for the user 12, or may be dynamically defined by the Email processes 18 and 20 or using an application external to the Email processes 18 and 20. The Important Persons List 22 may, for example, be automatically determined by the Email processes 18 and 20 based on the frequency of email messages sent to and/or received from different users. For example, the Important Persons List may consist of those users that the user 12 sent the most email messages to over the last month.

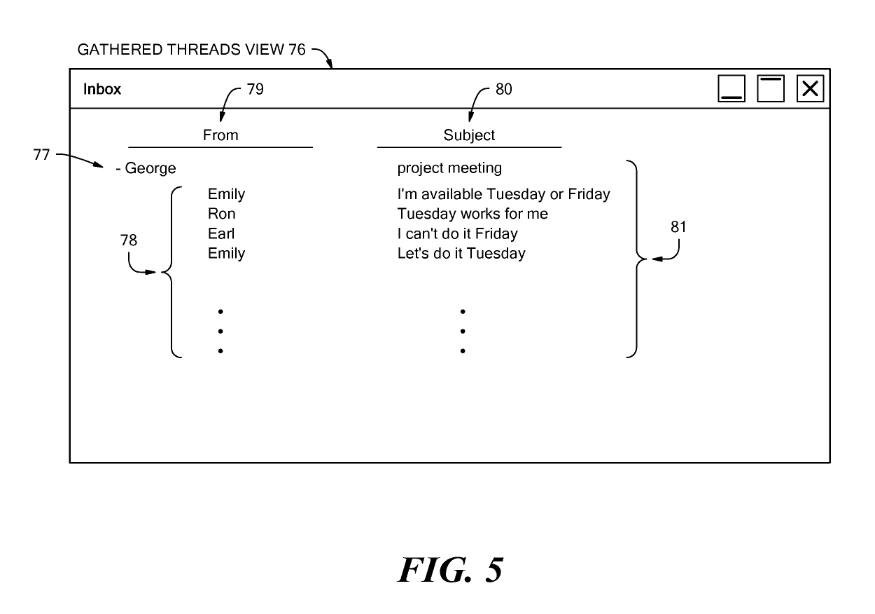

The User Interface 14 also includes a gathered threads view in which multiple messages in a message thread are displayed using a single entry in a list of message thread entries, and/or by a group of adjacent message entries corresponding to the multiple messages in the message thread, or in some other way that gathers indications of the multiple messages into a corresponding region of the User Interface 14. For example, the list of message thread entries in the gathered threads view provided in the User Interface 14 may be presented in a display of the User 12's Inbox message structure that shows message received by the Email Receive Process 20, or in a display of the User 12's Sent Items message structure that shows messages sent by the Email Send Process 18. As illustrated in FIG. 5, and discussed further below, use of selected proposed subject lines provided by the disclosed system may result in more useful “Subject:” field contents being presented in such a gathered threads view.

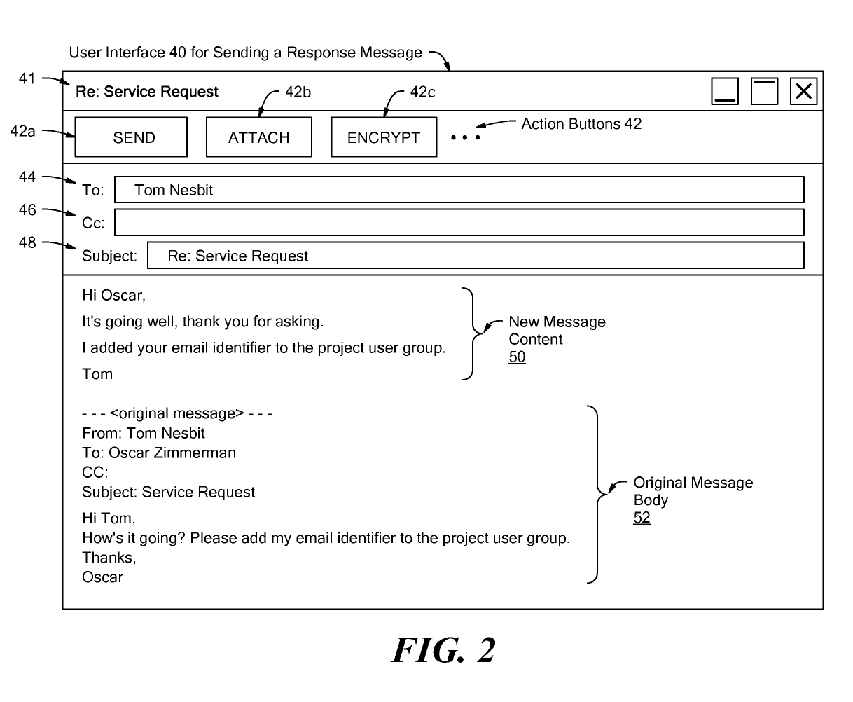

FIG. 2 is a simplified portion of a screen shot illustrating a portion of the User Interface 14 (FIG. 1) in accordance with an illustrative embodiment of the disclosed system. As shown in FIG. 2, the User Interface 40 is provided for sending a response message, and includes a number of Action Buttons 42, which may be clicked on by the User 12 to initiate corresponding actions. The Action Buttons 42 are shown including a Send button 42a which initiates sending of the response message, an Attach button 42b which initiates attaching of a document to the response message, and an Encrypt button 42c which initiates encryption of the response message. Other specific buttons for other corresponding actions may also be provided in the Action Buttons 42, and the specific buttons or the like provided in this way may vary from embodiment to embodiment.

The User Interface 40 is further shown including a “To:” field 44, in which is stored the name or email address of the primary addressee(s) of the response message, in this case “Tom Nesbit”. In the example of FIG. 2, the response message is a response to an originally received message from “Tom Nesbit”. The User Interface 40 further includes a “Cc:” field 46, which is used to store the name or email address of other recipients of the response message.

A “Subject:” field 48 stores a subject line that is to be included in the response message. In the example of FIG. 2, the “Subject:” field 48 is shown displaying its default contents, which is the contents of the “Subject:” field of the originally received message, in this case “Service Request”, having “Re:” prepended to it to indicate that the message is a response. Accordingly, the complete default contents of the “Subject:” field 48 is “Re: Service Request”. Therefore, in the example of FIG. 2, the User 12 has not modified the default contents of the “Subject:” field 48.

The User 12 has added the New Message Content 50 to the Original Message Body 52. The current contents of the “Subject:” field 48 is also reproduced in the top line 41 of the User Interface 40. In the example of FIG. 2, the User 12 is “Oscar Zimmerman”, who is the recipient of the original message.

During operation of the embodiment shown in FIG. 2, when the User 12 has finished composing the response message and clicks on the Send button 42a, the disclosed system operates to determine whether the contents of the “Subject:” field 48 has been modified from its default value by the User 12, for example by the User 12 directly typing a new subject line into the “Subject:” field 48, or by the User 12 otherwise directly editing the default contents of the “Subject:” field 48 using the keyboard. If the default value of the “Subject:” field 48 has been explicitly modified by the User 12 when the User 12 clicks on the Send button 42a, then the response message is transmitted with the “Subject:” field 48 including the user modified contents, and without generating and/or presenting any proposed subject lines to be used in the “Subject” field 48. Otherwise, if the default value of the “Subject:” field 48 has not been modified by the User 12 when the Send button 42a is clicked, then the disclosed system operates to generate one or more proposed subject lines that the User 12 can select from for use in the “Subject:” field 48.

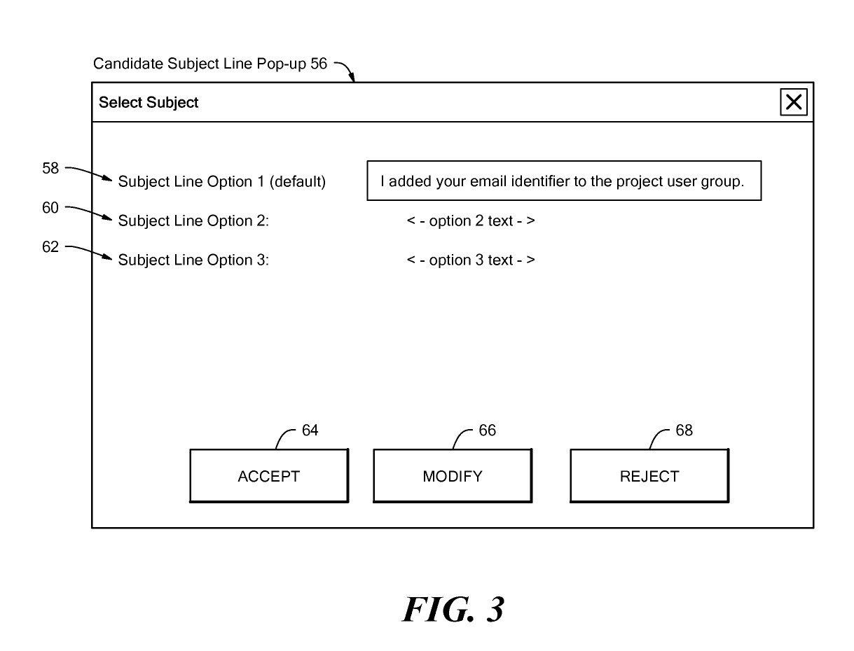

FIG. 3 is a simplified portion of a screen shot showing a dialog box that may be generated in response to the User 12 clicking on the Send button 42a of FIG. 2 when the default value of the “Subject:” field 48 in the User Interface 40 has not been explicitly modified by the User 12. As shown in FIG. 3, the Proposed Subject line Pop-up 56 displays a number of proposed subject lines, shown for purposes of illustration as a Subject Line Option 1 58, a Subject Line Option 2 60, and a Subject Line Option 3 62. While three proposed subject lines are presented to the User 12 in the example Pop-up 56 of FIG. 3, the disclosed system is not limited to such and embodiment, and alternatively more or less proposed subject lines may be presented.

The Pop-up 56 illustrates that in one embodiment of the disclosed system, a default proposed subject line, such as the Subject Line Option 1 58, which is shown consisting of the text “I added your email identifier to the project user group”, may be initially highlighted to indicate that it is the currently selected proposed subject line when the Pop-up 56 initially appears. In the example of FIG. 3, the text “I added your email identifier to the project user group” was derived from the New Message Content 50 shown in FIG. 2. In one embodiment of the disclosed system, one or more of the proposed subject lines may be generated based on new message content added to the response message, such as the New Message Content 50 shown in FIG. 2. In such an embodiment, the disclosed system may operate to ignore relatively unimportant text in the new message content, such as the introductory language “Hi Oscar, Its going well, thank you for asking” in the New Message Content 50 of FIG. 2. As a result, the automatically generated subject line “I added your email identifier to the project user group” was identified as the first relatively significant text in the New Message Content 50, and presented as the Subject Line Option 1 58.

The User 12 can click on another one of the proposed subject lines presented in the Pop-up 56 to make it the currently selected proposed subject line, and resulting in the text for that proposed subject line becoming highlighted, while the previous currently selected proposed subject line becomes no longer highlighted. In one embodiment, the currently selected proposed subject line is written into the “Subject:” field 48 of the User Interface 40 shown in FIG. 2. The “Subject:” field 48 thus continuously reflects the currently selected proposed subject line.

Three action buttons 64, 66 and 68 are provided in the Pop-up 56. When the User 12 clicks on the Accept button 64, the response message created in the User Interface 40 of FIG. 2 is transmitted, including the currently selected proposed subject line in the “Subject:” field 48. When the User 12 clicks on the Modify button 66, the user's cursor is placed in the text of the currently selected proposed subject line so that the User 12 can edit the currently selected proposed subject line. When the User 12 clicks on the Reject button 68, all proposed subject lines are rejected, and the User 12 is returned to the User Interface 40 of FIG. 2 without any of the proposed subject lines being written into the “Subject:” field 48.

While action buttons 64, 66 and 68 are shown for purposes of illustration in FIG. 3, those skilled in the art will recognize that the disclosed system may be embodied using any particular user interface construct that allows for the three action options to be presented, such a pull down menu, right click menu, or in some other way.

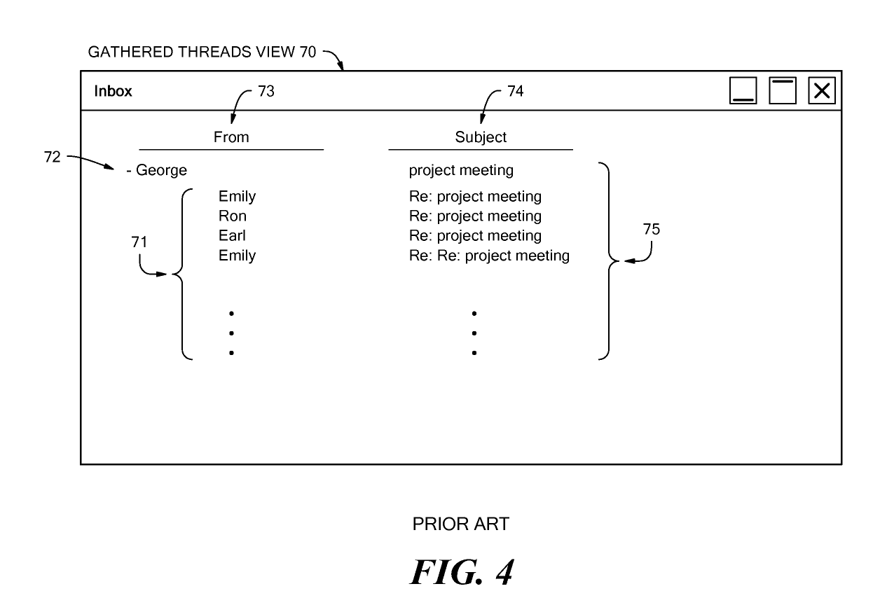

The disclosed system provides many advantages, some of which relate to its use in the context of gathered threads views of messages, as shown by FIGS. 4 and 5. FIG. 4 is a simplified screen shot showing a portion of an Inbox user display generated by a prior art system. In the Gathered Threads View 70 of FIG. 4, a parent message 72 from a user George has grouped beneath it a number of related child messages 71. The parent message 72, together with the related child messages 71, constitutes a gathered thread 75 of messages, sometimes referred to as a “conversation”. A From column 73 includes indications of the senders of each of the messages in the gathered thread 75, and a Subject column 74 includes indications of the “Subject:” field contents of each of the messages in the gathered thread 75. As often occurs, the prior art approach of FIG. 4 results in a series of uninformative “Subject:” field contents. In the example of FIG. 4, the “Subject:” field contents basically repeats the contents of the “Subject:” field from the parent message 72, with the additionally prepended “Re:” indicating that the child messages 71 are response messages. A user presented with such unhelpful “Subject:” field contents may be forced to explicitly click through to individual messages within the gathered thread 75 to determine any useful information contained in the messages.

FIG. 5 is a simplified screen shot showing a portion of an Inbox user display generated in accordance with an embodiment of the disclosed system. In the Gathered Threads View 76 of FIG. 5, a parent message 77 from a user George has grouped beneath it a number of related child messages 78. The parent message 77, together with the related child messages 78, constitutes a gathered thread 81 of messages, sometimes referred to as a “conversation”. A From column 79 includes indications of the senders of each of the messages in the gathered thread 81, and a Subject column 80 includes indications of the “Subject:” field contents of each of the messages in the gathered thread 81. As may be accomplished using an embodiment of the disclosed system, the “Subject:” field contents of the messages in the gathered thread 81 provides helpful information regarding the contents of each of the messages 78 that are children of the parent message 77. Since the child messages 78 are likely to be responses to the parent message 71, or to other child messages of the parent message 71, the disclosed system enables the responding users, in this case Emily, Ron and Earl, to select from automatically generated “abstracts” of the responses to be used as their “Subject:” field contents. As a result, the embodiment of the disclosed system used to generate the child messages 78 allowed responding users to select proposed subject lines consisting of “I'm available Tuesday or Friday”, “Tuesday works for me”, “I can't do it Friday”, and “Let's do it Tuesday”. The display of these user-selected, automatically generated subject lines in the “Subject:” field column 80 in the Gathered Threads View 76 of FIG. 5 enables a user to quickly understand important aspects of the child messages 78 contained in the gathered threads view 81, without having to click into specific ones of the child messages 78. A user reading the “Subject:” field column 80 can quickly ascertain that the project meeting can possibly be held on Tuesday, at least with respect to Emily, Ron, Earl and Emily. In this way, the disclosed system may provide a series of new subject lines describing the evolving context of a conversation. A user may still have to read individual messages, but is better able to prioritize which messages to read, and better able to return to the conversation at a later time and quickly find a specific message.

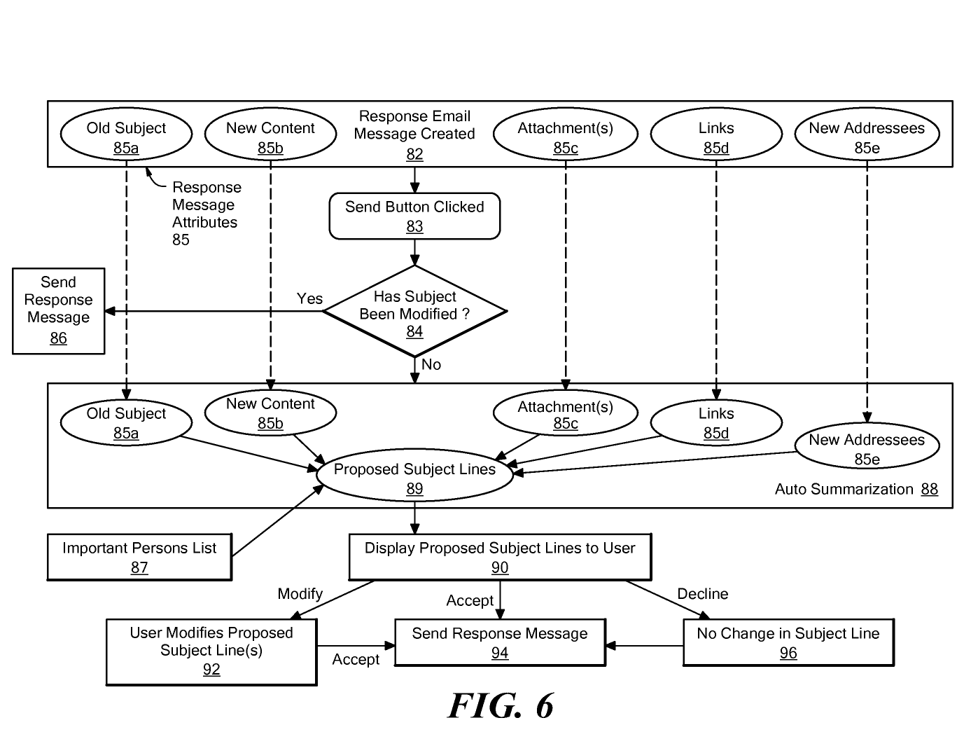

FIG. 6 is a flow chart showing steps performed in accordance with an embodiment of the disclosed system. At step 82, a response email message is created. For example, step 82 may be performed through the User Interface 14 shown in FIG. 1. The response email message created at step 82 is a reply to a previously received email message. The response email message created at step 82 has a number of attributes 85, which may be used to generate proposed subject lines. The attributes 85 of the response message are shown for purposes of illustration in FIG. 6 including an Old Subject 85a from the received email message, New Content 85b added by the responding user, Attachment(s) 85c attached to the response by the responding user, Links 85d added to the response by the responding user, such as URLs (Uniform Resource Locators), and/or New Addressees 85e added as recipients of the response message by the responding user. Other attributes or information regarding the response message may alternatively or additionally be used as basis for generating proposed subject lines.

When a trigger event is detected, such as the detection at step 83 of the user clicking on the Send button 42a shown in FIG. 2, the disclosed system determines whether the contents of the “Subject:” field for the response message has been changed from its original contents. The original contents of the “Subject:” field may, for example, consist of the contents of the “Subject:” field from the previously received message, with the text “Re:” prepended to it. In the event that the original contents of the “Subject:” field for the response is determined to have already been changed by the user, then step 84 is followed by step 86, in which the response message is sent. Otherwise, step 84 is followed by step 88.

In step 88, the disclosed system disclosed system performs an Auto Summarization step to generate one or more Proposed Subject Lines 89 from the response message attributes 85, and also potentially based on the contents of an Important Persons List 87. The step 88 may, for example, be performed by the Auto-Summarization Tool 16 of FIG. 1, and the Important Persons List 87 may correspond to the Important Persons List 22 shown in FIG. 1.

The Auto Summarization performed at step 88 may be accomplished using a variety of specific text analysis and information retrieval techniques. In one embodiment of the disclosed system, Proposed Subject Lines 89 are generated based on the newly added text contents of the response message. In such an embodiment, when the response message only contains one sentence or one line of text, then that sentence or line is used as the default or highest priority one of the Proposed Subject Lines 89. Furthermore, in such an embodiment, if the previously received message to which the response is a reply included a “Subject:” field contents of “Service Request”, and the responding user's response message body contained only one line: “Request to add your email id in USER GROUP ID is completed.”, then the default subject line of the Proposed Subject Lines 89 would be: “Request to add your email id in USER GROUP ID is completed”.

Generation of the Proposed Subject Lines 89 may be performed such that if the first few lines of the new text in the response message are trivial greeting sentences containing words such as “Hi”, “Hello John”, “Everyone,” “Gentlemen”, “I am fine” etc., then those sentences are ignored so that the first real sentence of the added response text can be used as one of the Proposed Subject Lines 89. For example, in the event that a user's response message contained the text: “Good morning everyone. Today's project meeting is mandatory”, then a default proposed subject line of the Proposed Subject Lines 89 might be as follows: “Today's project meeting is mandatory”. Various specific technologies, such as IBM®'s UIMA (Unstructured Information Management Architecture) may, for example, by used to support an implementation of such an embodiment.

In another embodiment of the disclosed system, the Auto Summarization step 88 may generate one or more of the Proposed Subject Lines 89 based on the type, name and/or contents of any file or files attached to the response message. For example, if a new file has been attached to the response message by the user, then the text “Attachment added:” followed by the name of the attached file might be used as one of the Proposed Subject Lines 89. Moreover, the disclosed system may be embodied such that the Auto Summarization step 88 examines the contents of certain types of attached documents, or the contents of all attached documents, when generating the Proposed Subject Lines 89. For example, if the attached document has a document type indicating it is a presentation document, then the disclosed system can operate to read the title of the presentation, and include the presentation title within one or more of the Proposed Subject Lines 89. Additionally, a text extraction tool, such as the DCS (Document Conversion Service) from IBM®, or such as Outside-In provided by Stellent, Inc., may be used in implementations of such an embodiment. Similarly, the disclosed system may be embodied to read the title from a word processing application document, and potentially also the author, last modification date, and other document metadata, for use as at least part of one or more of the Proposed Subject Lines 89.

The disclosed system may further operate to combine information extracted from newly attached documents with portions of newly added text in the response message to form one or more of the Proposed Subject Lines 89. For example, in the case where the newly added text is short, it might be included in its entirety in one of the Proposed Subject Lines 89, in combination with the name of a newly attached file. In another example, one proposed subject line might be derived from newly added text of the response message, while another proposed subject line may be derived from information regarding one or more newly attached documents.

In another embodiment of the disclosed system, links such as URLs (Uniform Resource Locators) that are added to the response message are used to generate at least a portion of one or more of the Proposed Subject Lines 89. For example, in such an embodiment, if the responding user is a Human Resource representative responding to an email message with the “Subject:” of “Clarification on HR policy”, they may attach a link to a Travel Policy section of a Human Resources manual stored in the Enterprise Data Repositories 28. In such a case, the Auto Summarization step 88 may operate by generating one of the Proposed Subject Lines 89 including text such as “Link to HR Travel policy” or “Link to information on Travel policy request”.

In addition, the Auto Summarization step 88 may include obtaining details associated with content indicated by a newly added link. An embodiment that processes newly added links in a response message to generate one or more of the Proposed Subject Lines 89 may be implemented in various ways. For example, in order to determine information regarding a link that might be included in one of the Proposed Subject Lines 89, an embodiment of the Auto-Summarization Tool 16 (FIG. 1) may communicate with one of the Enterprise Data Repositories 28 (FIG. 1) to which the link points, in order to obtain metadata about the linked information to be used as part of one or more of the Proposed Subject Lines 89. Alternatively, if the link is a URL pointing to a document within the Remote Web Content 32, an embodiment of the Auto-Summarization Tool 16 (FIG. 1) may use the link to read the title of a linked HTML document, which similarly may be used as part of one or more of the Proposed Subject Lines 89. In another alternative, if the link is an HTTP (HyperText Transfer Protocol) link of the format http:/NAME, then the NAME portion of the link may be extracted for use as at least a portion of one or more of the Proposed Subject Lines 89.

With regard to processing new addressees added by the responding user as recipients of the response message, the Auto Summarization step 88 may operate to compare such new addressees with the contents of the Important Persons List 87 to determine if there are any matches. If a determination is made that one of the new addressees is an important person for the responding user, then an indication of that addressee may be included as at least a portion of one or more of the Proposed Subject Lines 89.

Embodiments of the disclosed system may maintain the contents of the Important Persons List 87 in a variety of ways. In a first embodiment, the Important Persons List 87 stores indications of persons that are dynamically determined to be important to the user, for example based on a high frequency of communication with such persons, or by the user expressly defining them as important. In another approach, the Important Persons List 87 may be populated based on the roles and positions of persons within a business organization. For example, John Doe may be considered an important person to all members of a business organization if John Doe is a Director of the business organization. Accordingly, if John Doe is added as a new addressee for a response message, John Doe would be determined to be an important person based on the contents of the Important Persons List 87, and the disclosed system would generate a proposed subject line including the text “John Doe added to thread”.

In another aspect of the disclosed system, the Auto Summarization step 88 of FIG. 6 may generate one or more of the Proposed Subject Lines 89 based at least in part on a determination that the responding user has copied and pasted another email message into the body of the response message, thus joining two different email threads. Email users often perform such copy and paste operations, and then refer to the pasted messages within their response messages. In an embodiment of the disclosed system, the Auto Summarization step 88 may detect that such a copy and paste operation has been performed based on detection of the copied message within the response message. In response to such detection, the Proposed Subject Lines 89 may be generated to include one or more proposed subject lines having text indicating the inclusion of the pasted email message within the response message, for example text having a format such as “Mail <Title> added”, where <Title> is the title of the message that was copied into the response message.

Those skilled in the art will recognize that the above described approaches to performing Auto Summarization in step 88 of FIG. 6 are only examples, and that the disclosed system is not limited to such embodiments. Accordingly, the disclosed system may alternatively be embodied such that other specific techniques are used to generate one or more of the Proposed Subject Lines 89.

At step 90, the disclosed system displays the Proposed Subject Lines 89 to the user, for example using the Proposed Subject Line Pop-up 56 shown in FIG. 3, or some other appropriate user interface construct. The user is then allowed to select from the Modify, Accept or Decline options, for example by clicking on the buttons 66, 64 or 68 respectively, as shown in FIG. 3, or through some other appropriate user interface construct. If the user selects the Modify option, then step 90 is followed by step 92, in which the user is allowed to modify a currently selected one of the Proposed Subject Lines 89. If the user selects the Accept option, then step 90 is followed by step 94, in which the response message is sent including the currently selected one of the Proposed Subject Lines 89 as the “Subject:” field. If the user selects the Decline option, then step 90 is followed by step 96, in which none of the Proposed Subject Lines 89 are used as the “Subject:” field of the response message.

FIGS. 1 and 6 are block diagram and flowchart illustrations of methods, apparatus(s) and computer program products according to an embodiment of the invention. It will be understood that each block of FIGS. 1 and 6, and combinations of these blocks, can be implemented by computer program instructions. These computer program instructions may be loaded onto a computer or other programmable data processing apparatus to produce a machine, such that the instructions which execute on the computer or other programmable data processing apparatus create means for implementing the functions specified in the block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the block or blocks.

Those skilled in the art should readily appreciate that programs defining the functions of the present invention can be delivered to a computer in many forms; including, but not limited to: (a) information permanently stored on non-writable storage media (e.g. read only memory devices within a computer such as ROM or CD-ROM disks readable by a computer I/O attachment); (b) information alterably stored on writable storage media (e.g. floppy disks and hard drives); or (c) information conveyed to a computer through communication media for example using wireless, baseband signaling or broadband signaling techniques, including carrier wave signaling techniques, such as over computer or telephone networks via a modem.

While the invention is described through the above exemplary embodiments, it will be understood by those of ordinary skill in the art that modification to and variation of the illustrated embodiments may be made without departing from the inventive concepts herein disclosed. Moreover, while the preferred embodiments are described in connection with various illustrative program user interface constructs, such as buttons, one skilled in the art will recognize that they may be embodied using a variety of specific user interface constructs.

We claim:

1. A method of providing an abstract of a response message within a subject field of said response message, comprising:
generating at least one proposed subject line, wherein said proposed subject line is different from an original contents of said subject field for said response message;
receiving a user indication that said proposed subject line is to be inserted into said subject field of said response message;
inserting said proposed subject line into said subject field of said response message in response to said user indication that said proposed subject line is to be inserted into said subject field of said response message; and
sending said response message including said proposed subject line in said subject field of said response message.

2. The method of claim 1, further comprising:
wherein said generating comprises generating a plurality of proposed subject lines;
wherein said user indication further comprises an indication of an accepted one of said plurality of proposed subject lines; and
wherein said inserting further comprises inserting said accepted one of said plurality of proposed subject lines into said subject field of said response message.

3. The method of claim 1, further comprising:
determining whether said user has modified said original contents of said subject field for said response message; and
wherein said generating said proposed subject line is performed only in the event that said user has not modified said original contents of said subject field for said response message.

4. The method of claim 3, wherein said generating is performed responsive to detecting that said user has requested that said response message be sent and has not modified said original contents of said subject field for said response message.

5. The method of claim 2, wherein said generating is performed responsive to one of the set consisting of new contents added by said user to said response message, an attachment file included by said user with said response message, at least one link included by said user in said response message, metadata associated with said at least one link included by said user in said response message, content identified by said at least one link included by said user in said response message, and a new addressee of said response message added by said user.

6. The method of claim 5, wherein said generating is performed further responsive to an important person list associated with said user.

7. The method of claim 2, further comprising generating a proposed subject line user interface for displaying said plurality of proposed subject lines and enabling said user to provide said indication of said accepted one of said plurality of proposed subject lines.

8. The method of claim 7, wherein said proposed subject line user interface enables said user to select an action from the set of actions consisting of accepting one of said plurality of proposed subject lines, modifying one of said plurality of proposed subject lines, and rejecting said proposed subject lines.

9. A system including a computer readable medium, said computer readable medium having program code stored thereon for providing an abstract of a response message within a subject field of said response message, said program code comprising:
program code for generating at least one proposed subject line, wherein said proposed subject line is different from an original contents of said subject field for said response message;
program code for receiving a user indication that said proposed subject line is to be inserted into said subject field of said response message;
program code for inserting said proposed subject line into said subject field of said response message in response to said user indication that said proposed subject line is to be inserted into said subject field of said response message; and
program code for sending said response message including said proposed subject line in said subject field of said response message.

10. The system of claim 9, further comprising:
wherein said program code for generating comprises program code for generating a plurality of proposed subject lines;
wherein said user indication further comprises an indication of an accepted one of said plurality of proposed subject lines; and
wherein said program code for inserting further comprises inserting said accepted one of said plurality of proposed subject lines into said subject field of said response message.

11. The system of claim 9, wherein said program code further comprises:
program code for determining whether said user has modified said original contents of said subject field for said response message; and
wherein said program code for generating said proposed subject line performed said generating only in the event that said user has not modified said original contents of said subject field for said response message.

12. The system of claim 11, wherein said program code for generating performs said generating responsive to detecting that said user has requested that said response message be sent and has not modified said original contents of said subject field for said response message.

13. The system of claim 10, wherein said program code for generating performs said generating responsive to one of the set consisting of new contents added by said user to said response message, an attachment file included by said user with said response message, at least one link included by said user in said response message, metadata associated with said at least one link included by said user in said response message, content identified by said at least one link included by said user in said response message, and a new addressee of said response message added by said user.

14. The system of claim 13, wherein said program code for generating performs said generating further responsive to an important person list associated with said user.

15. The system of claim 10, further comprising program code for generating a proposed subject line user interface for displaying said plurality of proposed subject lines and enabling said user to provide said indication of said accepted one of said plurality of proposed subject lines.

16. The system of claim 15, wherein said proposed subject line user interface enables said user to select an action from the set of actions consisting of accepting one of said plurality of proposed subject lines, modifying one of said plurality of proposed subject lines, and rejecting said proposed subject lines.

17. A computer program product including a computer readable medium, said computer readable medium having program code stored thereon for providing an abstract of a response message within a subject field of said response message, said program code comprising:
program code for generating at least one proposed subject line, wherein said proposed subject line is different from an original contents of said subject field for said response message;
program code for receiving a user indication that said proposed subject line is to be inserted into said subject field of said response message;
program code for inserting said proposed subject line into said subject field of said response message in response to said user indication that said proposed subject line is to be inserted into said subject field of said response message; and
program code for sending said response message including said proposed subject line in said subject field of said response message.

18. A computer data signal embodied in a carrier wave, said computer data signal having program code for providing an abstract of a response message within a subject field of said response message stored thereon, said program code comprising:
program code for generating at least one proposed subject line, wherein said proposed subject line is different from an original contents of said subject field for said response message;
program code for receiving a user indication that said proposed subject line is to be inserted into said subject field of said response message;
program code for inserting said proposed subject line into said subject field of said response message in response to said user indication that said proposed subject line is to be inserted into said subject field of said response message; and
program code for sending said response message including said proposed subject line in said subject field of said response message.

19. A system for providing an abstract of a response message within a subject field of said response message, said program code comprising:
means for generating at least one proposed subject line, wherein said proposed subject line is different from an original contents of said subject field for said response message;
means for receiving a user indication that said proposed subject line is to be inserted into said subject field of said response message;
means for inserting said proposed subject line into said subject field of said response message in response to said user indication that said proposed subject line is to be inserted into said subject field of said response message; and
means for sending said response message including said proposed subject line in said subject field of said response message.
